(19) United States
(12) Patent Application Publication
(10) Pub. No.: US 2009/0055133 A1
(43) Pub. Date: Feb. 26, 2009

(54) Method for the asynchronous, space-saving data acquisition within a continuous measured value storage

(76) Inventors: Wolfgang Schworer, Loffingen (DE); Meinrad Gotz, Bonndorf (DE)

Correspondence Address: MUIRHEAD AND SATURNELLI, LLC, 200 FRIBERG PARKWAY, SUITE 1001, WESTBOROUGH, MA, 01581, US

(21) Appl. No.: 12/154,727

(22) Filed: May 27, 2008

Related U.S. Application Data
(63) Continuation of application No. 10/471,316, filed on Sep. 9, 2003.

(30) Foreign Application Priority Data
Mar. 14, 2001 (DE) 101 12 038.9

(51) Int. Cl. G06F 15/00

(52) U.S. Cl. 702/187

(57) ABSTRACT

A system and method for the acquisition and storage of measured values includes continuously acquiring measured values by at least one sensor in a predefined first measurement interval. The acquired measured values are stored in a measured value memory. Upon occurrence of an event detected by an event sensor one or more further measured value(s) may be acquired by the at least one sensor and/or one or more further measured values may be acquired with a further measurement interval in an asynchronous manner to the first measurement interval and stored in the measured value memory.

### CROSS-REFERENCE TO RELATED APPLICATIONS

This application is a continuation of U.S. patent application Ser. No. 10/471,316 (pending) filed on Sep. 9, 2003, which is incorporated herein by reference

### BACKGROUND OF THE INVENTION

1. Technical Field

This application relates to a method of measured value acquisition and storage.

2. Description of the Related Art

Measuring instruments or the like are known from the related art, which, triggered by the occurrence of a certain event such as, for example, the opening of a door or the like, gather and store, in an especially provided measuring-data memory, one or several items of measuring data in fixedly predetermined and as a rule equal time intervals. Measured value gathering is aborted in the same way, preferably due to the fact that the above-mentioned event is no longer occurring, e.g., when the above-mentioned door contact is closed again. Prior to the occurrence of the above-mentioned event or after the above-mentioned event is no longer occurring no measured-values are gathered or stored.

Measured value acquisition and storage methods are used in those cases in which measured values are to be gathered and stored during these periods; continuous measured values are gathered by at least one measured value sensor in a fixedly predetermined first measuring cycle and the measured values gathered are stored in a measured value memory. Furthermore, the time of the occurrence of the event, as well as the non-occurrence of the event is additionally stored in order to obtain a corresponding allocation. Any further storage measures are omitted due to the large memory required.

It is thus desirable to design and refine the known methods of measured value acquisition and storage in such a way that measured value acquisition and storage adapted to a special event is possible without a substantially greater memory space being required.

### SUMMARY OF THE INVENTION

According to an embodiment of the system described herein, subsequently to the occurrence of an event gathered by an event sensor, one or several additional measured values are gathered asynchronously to the first measuring cycle by the at least one measured value sensor and/or by at least one additional measured value sensor, the measured values being stored in the measured value memory. In this way, the measured-data acquisition is instantaneously adapted to the occurrence of an event. This is particularly appropriate when the measured value acquisition takes place in great time intervals during the first measuring cycle, so that in the method according to the related art changes of state due to the occurrence of the event are not detected. In the method according to the system described herein, a memory space is only to be provided directly at the occurrence of the event. Moreover, no additional measuring channel is required.

According further to the system described herein, further measured values are gathered in a fixedly predetermined second measuring cycle (which may or may not be identical to the first measuring cycle). A plurality of applications is comprehensively covered by this method, in particular in the areas of food distribution and food warehousing. Using this method, the temperature variation in the cargo space of a truck when the truck doors are open and the temperature variation in a food container when the container cover is open may be detected in real time and may be documented precisely via the variable measuring cycle. A measuring rate, adapted to the event, is performed which makes it possible to accurately follow the change from a static system (e.g., the temperature variation with a closed food container) to a dynamic system (e.g., a subsequent opening of the food container cover).

According further to the system described herein, further measured values are gathered as long as the event continues to exist. This variant ensures that the preferably increased measuring rate and thus an increased memory requirement are only maintained as long as high dynamics of the measured variable is anticipated. At times when only a minor variation of the measured value is to be anticipated, measured value acquisition and storage are omitted.

According further to the system described herein, as a result of non-occurrence of the event (as detected by the event sensor), one or several additional measured value(s) are gathered by the at least one measured value sensor and/or by the at least one further measured value sensor asynchronously to the first measuring cycle and/or asynchronously with the second measuring cycle, the additional measured values being stored in the measured value memory. This design of the system described herein is a logical consequence of the modified measured value acquisition due to an asychronous occurrence of an event. Since, in the case of an asynchronous non-occurrence of an event, as well as in the case of an asynchronous occurrence of an event, a strong variation of one of the above-mentioned measured values is to be anticipated, it is appropriate at this point in time to again perform a measurement and storage of the measured value.

According further to the system described herein, the additional measured values are included in the fixedly predetermined first measuring cycle. This consequently means that a measuring cycle is associated with each state detected by one or several event sensors. Thus, measured value acquisition specifically tailored to the respective state takes place. If high dynamics of a measured value is anticipated, a high frequency measuring cycle is preferably applied to that state; if, however, low dynamics of the measured value is anticipated, a low cycle frequency of the measuring cycle is preferably chosen. It is not impossible here that different measuring cycles are associated with different measured value sensors (associated with individual measuring channels as a rule).

According further to the system described herein, the time of the measured value acquisition start is stored in the measured value memory at the beginning of the measured value acquisition. This point in time, preferably an absolute time, is used for the reconstruction and the chronological allocation of each series of measurements.

According further to the system described herein, for each stored measured value, the time difference between its measured value acquisition time and the measured value acquisition time of the previous measured value is stored in the measured value memory. This variant of the system described herein is particularly advantageous if, as in the above-mentioned case, the occurrence of an event is to be exactly determined and/or if the time of non-occurrence of the event is significant. If this is not the case, it is sufficient in principle to only apply different measuring cycles to different events or states, so that in this way a reconstruction of the chronological measured value sequence is possible.

According further to the system described herein, the time difference is stored as a 15-bit data word. At a time resolution of one second, the slowest measuring rate is 32,767 seconds, or approximately 9.1 hours. Of course, scaling in 100 milliseconds, 10 milliseconds, 1 millisecond, etc., is possible, whereby each time resolution is increased by the factor 10 vis-à-vis the previous resolution. At the same memory width, the slowest measuring cycle is reduced by the factor 10.

According further to the system described herein, for each stored measured value, the state of the event is stored in the measured value memory. This memory organization makes it possible to perform and to store asynchronous measurements within the measuring cycles predetermined by the instrument and also to additionally implement two different measuring rates, depending on the state of the external signal.

According further to the system described herein, the state of the event is stored as a 1-bit data word. This, together with the 15-bit data word for the time difference, results in a 16-bit data word which corresponds to the usual memories having 16-bit memory structures.

It is also provided that the measured values are stored as 15 bit data words having a sign bit each. This makes it possible to establish a numerical range between −32,768 and +32,767, allocation to the above-mentioned time memory and the event memory preferably taking place. Each measured value thus includes a 16-bit data word from whose absolute value (incl. sign) and the chronological allocation (incl. event state) also including a 16-bit data word. If several measuring channels are used, it is of course sufficient (as long as the measured value acquisition in the individual channels takes place simultaneously) to provide only one memory for the time and the respective state of the event which is associated with all measuring channels.

According further to the system described herein, temperature sensors, air moisture sensors, flow sensors, flue gas sensors, and/or the like such as e.g., CO₂, pH, air moisture sensors are used as measured value sensors. In principle, the type of sensor used is not subject to limitation.

According further to the system described herein, at least one door contact and/or one measured value sensor is used as event sensor. It is provided in particular that the opening or closing of the door contact, exceeding or dropping below a threshold, exceeding or dropping below the modification of a measuring signal, or the like represent the event. All above-mentioned events are suitable to be represented by a 1-bit data word, which means in particular that the presence of a respective event is representable by a logical “1”, for example, and the non-presence or non-occurrence of the respective event is representable by a logical “0.”

### BRIEF DESCRIPTION OF THE DRAWING

An exemplary embodiment of the system described herein is illustrated in the drawing and is explained in greater detail in the following.

FIG. 1 shows a sequence diagram for the gathering of measured values over time.

FIG. 2 shows a configuration of a measured value memory.

### DETAILED DESCRIPTION OF VARIOUS EMBODIMENTS

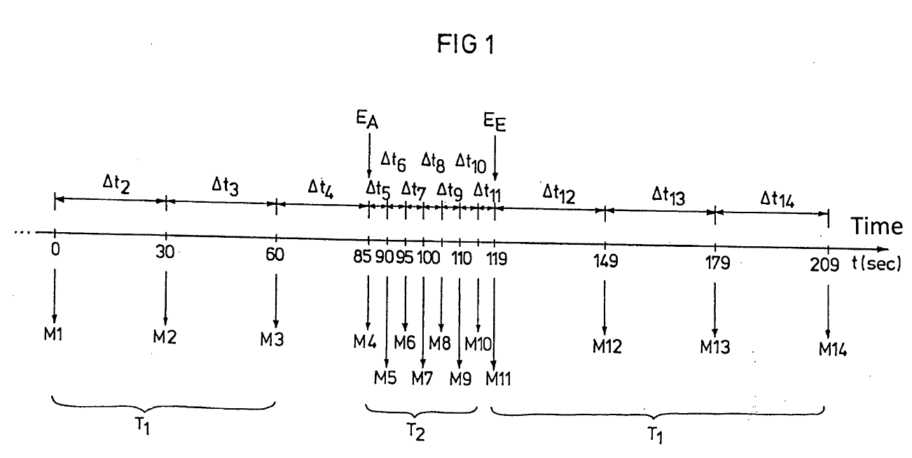

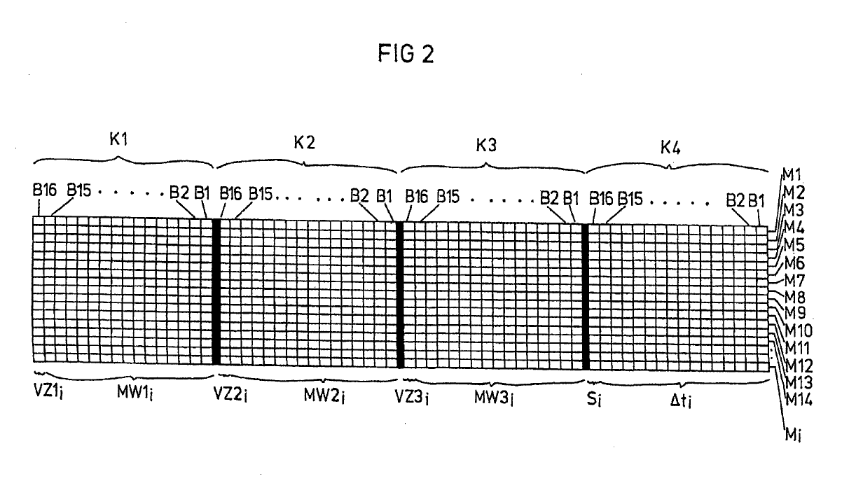

In general, FIGS. 1 and 2 show as an example the memory space-saving method according to the system described herein for asynchronous data acquisition within a continuous measured value storage.

A continuous measured value acquisition and storage of different measured variables MW1, MW2, MW3, e.g., temperature, humidity, flow etc., in a fixedly set measuring cycle initially takes place in the method. An asynchronous occurrence EA of an event (e.g., closing of a door contact, exceeding or dropping below a measured value or measured value gradient) may trigger a measurement asynchronous with the previous measuring cycle T1 and the measuring result may be stored. As long as the event triggering the measurement continues to exist, another measuring cycle T2 may be activated. When the external event asynchronously ceases to exist, a new measurement is performed, the measured values MW1, MW2, MW3 are stored, and switching to the previous measuring cycle T1 takes place. In FIG. 1, a continuous time frame is shown applied over all measuring cycles, for example, continuously running from 0 to 209 seconds over the first T1 measuring cycle, the T2 measuring cycle, and the second T1 measuring cycle.

The function of the storage-saving storage process is explained in detail below:

If a measuring instrument is preprogrammed for a measuring sequence, the following values, among others, may be stored in the instrument:
Measuring cycle T1 for an external signal S=“0”
(corresponding to “normal state”—no event—): e.g., 30 seconds.
Measuring cycle T2 for an external signal S=“1”
(corresponding to “modified state”—occurrence of event—): e.g., 5 seconds.
Number of channels to be measured: e.g., 3 channels K₁, K₂, K₃
Starting date and starting time of the measuring instrument t1=0:

### On Dec. 10, 2000 e.g., at 5:15 p.m.

It is intended to store the measured values in a storage space-saving manner as 15 bit numbers plus a sign bit. This makes it possible to create a numerical range between −32,768 and +32,767.

In addition to each measured value (thus three measured values MW1, MW2, MW3 for three channels K1, K2, K3), the time interval (also as a 15 bit number) to the previous measurement is stored expressed in seconds. Through this scaling and this memory variable, the slowest measuring rate may be 32,767 seconds (approximately 9.1 hours) and external events may be temporally resolved to 1 second.

Of course, scaling in 100 ms, 10 ms, 1 ms, etc., is also possible, whereby each time resolution in increased by the factor 10. For the same memory width, the slowest measuring cycle is reduced by the factor 10. This may be compensated, however, by increasing the memory width.

The sixteenth bit of the 16-bit memory is used as the state bit of the external signal S. This memory organization makes it possible to perform and to store asynchronous measurements within the measuring cycle T1, T2 predetermined by the (measuring) instrument and also to additionally implement two different measuring rates, depending on the state S=“1” or S=“0” of the external signal.

The chronological course of the method according to the system described herein and the associated memory organization are described in greater detail in the following. For this purpose, the diagram according to FIG. 1 shows as an example how “event-controlled” measured values are acquired in the “time-controlled” log operation.

The method according to the system described herein is illustrated by an example below:
M1) The measurement is started. The door contact is opened; the external signal S shows the value “0”. The first measured value acquisition M1 takes place at time t1=0 seconds. Measured value acquisition M1 is triggered by using a clock, a start button, a start signal, or via a PC. In the example, a cycle rate of 30 seconds is set as measuring cycle T1, so that the time-controlled measurements take place after t2=30 seconds, t3=60 seconds, t4=90 seconds, etc., provided no external event interferes with the measuring process. Time interval Δti between the i-th and the (i-1)-th measured value acquisition M1 and M (i-1) is thus Δti=30 seconds.
M2) A second time-controlled measured value acquisition M2 takes place after t2=30 seconds.
M3) A third time-controlled measured value acquisition M3 takes place after t3=60 seconds.
M4) After 25 seconds, thus asynchronously with the 30-second measuring cycle T1, door contact (Signal S=“1”) closes. This triggers measured value acquisition M4 at the time of closing. Subsequently to their acquisition, measured values MW14, MW24, and MW34 are stored in their storage spaces provided for each, and switching to the second measuring cycle T2 takes place. The cycle rate of measuring cycle T2 is 5 seconds in the example.
M5-M10) As long as the door contact is closed, the (measuring) instrument, for example, measures in a 5 second frequency (Δti=5 seconds) of the second measuring cycle T2. Measuring values MW1i, MW2i, MW3i where 1=5 . . . 10 are acquired at he points in time t5=90 seconds, t6=96 seconds, t7=100 seconds, t8=105 seconds, t9=110 seconds, t10=115 seconds.
M11) Door contact (Signal S=“0”) opens asynchronously with 5-second measuring cycle T2. In the example, this is the case after another 4 seconds. This triggers measured value acquisition M11 at the time of opening (Δt11=119 seconds), measured values MW111, MW211, and MW311 are stored, and switching back to the first measuring cycle T1 takes place (here: Δti=30 seconds).
M12-M14 Starting from point in time t11 of the eleventh measured value acquisition M11, the subsequent measurements are again performed every 30 seconds.

The memory organization during measured value acquisition is thus as follows: The starting time and the starting date are stored in the instrument at point in time t1. Beginning at this starting date, the memory is “filled” as explained in Table 1.

TABLE 1
Memory Organization

| Measured | Measured | Measured | | | | |
|---|---|---|---|---|---|---|
| Values | Values | Values | Switch | | Time | Reference |
| Channel 1 | Channel 2 | Channel 3 | State S | | Difference | to |
| -K1- | -K2- | -K3- | -K4- | | Δti | Diagram |
| 23° C. | 45° C. | −15° C. | 0 | 0 | (sec) | M1 |
| 25.4° C. | 43.6° C. | −15.3° C. | 0 | 30 | (sec) | M2 |
| 25.8° C. | 47.2° C. | −14.2° C. | 0 | 30 | (sec) | M3 |
| 26.1° C. | 51.7° C. | −13.9° C. | 1 | 25 | (sec) | M4 |
| 25.5° C. | 51.9° C. | −14.1° C. | 1 | 5 | (sec) | M5 |
| 26.7° C. | 52.4° C. | −14.3° C. | 1 | 5 | (sec) | M6 |
| 26.9° C. | 52.9° C. | −14.6° C. | 1 | 5 | (sec) | M7 |
| 26.3° C. | 51.6° C. | −14.4° C. | 1 | 5 | (sec) | M8 |
| 26.1° C. | 51.2° C. | −14.3° C. | 1 | 5 | (sec) | M9 |
| 25.8° C. | 50.9° C. | −13.9° C. | 1 | 5 | (sec) | M10 |
| 26.7° C. | 50.9° C. | −14.0° C. | 0 | 4 | (sec) | M11 |
| 26.2° C. | 51.5° C. | −13.5° C. | 0 | 30 | (sec) | M12 |
| 25.7° C. | 50.4° C. | −13.0° C. | 0 | 30 | (sec) | M13 |
| 25.2° C. | 49.9° C. | −12.6° C. | 0 | 30 | (sec) | M14 |

The corresponding bit assignment is illustrated in FIG. 2 as follows:

Time difference (Δti), between measured value acquisition time (ti) of the instantaneous measured value (MW1i, MW2i, MW3i) and measured value acquisition time (ti-1) of the previous measured value (MW1i-1, MW2i-1, MW3i-1), assigned to each stored measured value (MW1i, MW2i, MW3i), is stored in measured value memory (K4) in such a way that time difference (Δti) is stored as a 15-bit data word B1, B2, B3, B4, B5, B6, B7, B8, B9, B10, B11, B12, B13, B14, B15. In addition to each stored measured value MW1i, MW2i, MW3i, the state Si of the event is stored in measured value memory K4, the latter being stored as one bit data word B16. Measured values MW1i, MW2i, MW3i are stored as 15-bit data words, and each assigned a sign bit. The latter is identified by reference number B16 in connection with Vz1i, Vz2i, and Vz3i.

This method has the following advantages:

This method provides a time-controlled instrument which responds to asynchronous events in that measured values relevant at the time of the event are stored and (if so desired) the measuring cycle is switched.

The memory is optimally utilized by using the selected storage method, since neither the time of day nor the date has to be stored. Due to the simultaneous storage of the time difference to the last measurement and the state of the event contact, the reading device (e.g., a personal computer (PC) or the like, or a terminal), beginning with the starting time once stored, may display the precisely timed “logged” measured values and events.

It is thus possible to acquire, store, and display asynchronous events within a time-controlled logging process.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

1.-14. (canceled)

15. A method of measured value acquisition and storage in which measured values are continuously gathered by at least one measured value sensor in a fixedly predetermined first measuring cycle, and the measured values gathered are stored in a measured value memory, wherein, due to the occurrence of an event, detected by an event sensor, one or several other measured value(s) are gathered by the at least one measured value sensor and/or by at least one additional measured value sensor asynchronously having both an independent rate and an independent phase with the first measuring cycle or any other measuring cycle and are stored in the measured value memory, wherein at a start of the measured value acquisition, a point in time of the measured value acquisition start is stored in the measured value memory, and wherein the point in time of the measured value acquisition start is a point in a continuous time frame applied over all measuring cycles.

16. The method as recited in claim 15, wherein the additional measured values are gathered in a fixedly predetermined second measuring cycle.

17. The method as recited in claim 15, wherein the additional measured values are gathered as long as the event continues to exist.

18. The method as recited in claim 15, wherein, due to the non-occurrence of the event, detected by the event sensor, one or several additional measured value(s) are gathered by the at least one measured value sensor and/or the at least one other measured value sensor asynchronously with the first measuring cycle and/or asynchronously with the second measuring cycle and are stored in the measured value memory.

19. The method as recited in claim 18, wherein the additional measured values are gathered in the fixedly predetermined first measuring cycle.

20. The method as recited in claim 15, wherein the time difference, between measured value acquisition time of the instantaneous measured values and measured value acquisition time of the previous measured values, associated with each stored measured value, is stored in the measured value memory.

21. The method as recited in claim 20, wherein the time difference is stored as a 15-bit data word.

22. The method as recited in claim 15, wherein the state of the event is stored for each stored measured value in the measured value memory.

23. The method as recited in claim 22, wherein the state of the event is stored as a 1-bit data word.

24. The method as recited in claim 15, wherein the measured values are stored as 15 bit data words plus one sign bit each.

25. The method as recited in claim 15, wherein at least one temperature sensor, at least one air moisture sensor, or at least one flow sensor, is used as the measured value sensor.

26. The method as recited in claim 15, wherein at least one door contact and/or one measured value sensor is used as the event sensor.

27. The method as recited in claim 15, wherein the event is the closing of a door contact, the excess or dropping below a threshold value, or the excess or dropping below a change of a measuring signal.

28. A method of measured value acquisition and storage, comprising:
gathering at least one measured value in a first measuring cycle with at least one measured value sensor;
storing said at least one measured value in a measured value memory;
detecting an occurrence of an event with at least one event sensor;
gathering at least one other measured value asynchronously having both an independent rate and an independent phase to the first measuring cycle; and
storing said at least one other measured value in said measured value memory, wherein a start time of said gathering at least one measured value in a first measuring cycle with at least one measured value sensor is stored in said measured value memory, and wherein the start time of the gathering the at least one measured value is a point in a continuous time frame applied over all measuring cycles.

29. The method as recited in claim 28, wherein a time of gathering of each measured value of said at least one measured value is compared with a time of gathering of at least one previous measured value and a time difference is stored in said measured value memory.

30. A method of measured value acquisition and storage, comprising:
continuously gathering measured values by at least one measured value sensor in a fixedly predetermined first measuring cycle; and
storing the measured values in a measured value memory, wherein, due to the occurrence of an event, detected by an event sensor, one or several other measured value(s) are gathered by the at least one measured value sensor and/or by at least one additional measured value sensor asynchronously having both an independent rate and an independent phase with the first measuring cycle or any other measuring cycle and are stored in the measured value memory, wherein at a start of the measured value acquisition, a point in time of the measured value acquisition start is stored in the measured value memory, and wherein the point in time of the measured value acquisition start is a point in a continuous time frame applied over all measuring cycles.

31. The method as recited in claim 30, wherein the additional measured values are gathered in a fixedly predetermined second measuring cycle.

32. The method as recited in claim 30, wherein the additional measured values are gathered as long as the event continues to exist.

33. The method as recited in claim 30, wherein, due to the non-occurrence of the event, detected by the event sensor, one or several additional measured value(s) are gathered by the at least one measured value sensor and/or the at least one other measured value sensor asynchronously with the first measuring cycle and/or asynchronously with the second measuring cycle and are stored in the measured value memory.

34. The method as recited in claim 30, wherein the time difference, between measured value acquisition time of the instantaneous measured values and measured value acquisition time of the previous measured values, associated with each stored measured value, is stored in the measured value memory.

35. A method of measured value acquisition and storage, comprising:
continuously gathering measured values by at least one measured value sensor in a fixedly predetermined first measuring cycle; and
storing the measured values in a measured value memory, wherein, due to the occurrence of an event, detected by an event sensor, one or several other measured value(s) are gathered by the at least one measured value sensor and/or by at least one additional measured value sensor asynchronously having both an independent rate and an independent phase with the first measuring cycle or any other measuring cycle and are stored in the measured value memory, wherein at a start of the measured value acquisition, a point in time of the measured value acquisition start is stored in the measured value memory, and wherein the point in time of the measured value acquisition start is a point in a continuous time frame applied over all measuring cycles and wherein, due to the non-occurrence of the event, detected by the event sensor, one or several additional measured value(s) are gathered by the at least one measured value sensor and/or the at least one other measured value sensor asynchronously with the first measuring cycle and/or asynchronously with the second measuring cycle and are stored in the measured value memory.

36. The method as recited in claim 35, wherein the additional measured values are gathered in the fixedly predetermined first measuring cycle.

37. A method of measured value acquisition and storage, comprising:
continuously gathering measured values by at least one measured value sensor in a fixedly predetermined first measuring cycle; and
storing the measured values in a measured value memory, wherein, due to the occurrence of an event, detected by an event sensor, one or several other measured value(s) are gathered by the at least one measured value sensor and/or by at least one additional measured value sensor asynchronously having both an independent rate and an independent phase with the first measuring cycle or any other measuring cycle and are stored in the measured value memory, wherein at a start of the measured value acquisition, a point in time of the measured value acquisition start is stored in the measured value memory, and wherein the point in time of the measured value acquisition start is a point in a continuous time frame applied over all measuring cycles and wherein at least one temperature sensor, at least one air moisture sensor, or at least one flow sensor, is used as the measured value sensor.
